(19) United States
(12) Patent Application Publication
(10) Pub. No.: US 2004/0031177 A1
(43) Pub. Date: Feb. 19, 2004

(54) Apparatus and method for forming signs

(75) Inventors: Thomas A. Gordon, South Glastonbury, CT (US); Joseph W. Stempien, Newington, CT (US)

Correspondence Address: Marina F. Cunningham, McCormick, Paulding & Huber LLP, CityPlace II, 185 Asylum Street, Hartford, CT, 06103, US

(73) Assignee: Gerber Scientific Products, Inc., South Windsor, CT

(21) Appl. No.: 10/446,356

(22) Filed: May 28, 2003

Related U.S. Application Data
(60) Provisional application No. 60/383,929, filed on May 28, 2002.

(51) Int. Cl. G09F 13/28

(52) U.S. Cl. 40/551; 362/812

(57) ABSTRACT

A sign letter includes a front plate, a back plate, and a side wall sandwiched between the front and back plate. The side wall includes a plurality of cavities formed by removal of side wall material for allowing the side wall to be easily bent to the shape of the sign letter. The side wall also comprises one-piece construction and includes at least one feature integral thereto that allows joining of the side wall with either the front plate or the back plate. The sign letter is automatically formed on a router with computer instructions to cut the front plate, the back plate and the side wall and to remove unnecessary material therefrom. The sign letter also includes a lighting system for illuminating the sign letter.

The present application claims priority from and incorporates by reference U.S. Provisional Application Serial No. 60/383,929 filed May 28, 2002.

### BACKGROUND OF THE INVENTION

1. Technical Field

The present invention relates to making letters for signs and, more particularly, to making plastic letters therefor.

2. Background of Prior Art

Conventional sign making for letters is highly labor intensive. Each letter is individually fabricated. Each letter includes a front plate, a back plate, and side walls or returns. The back plate and side walls are typically fabricated from sheet metal, whereas the front plate is typically fabricated from translucent material, such as acrylic or polycarbonate material. Since the side walls or returns are formed from metal, the sheet material must be specifically shaped for each letter.

Additionally, most existing signs use neon for lighting purposes. However, neon lights are associated with high voltage and high temperatures.

Therefore, there is a need for improved sign letters and for a method for fabricating the sign letters that is less labor intensive and more energy efficient.

### SUMMARY OF THE INVENTION

According to the present invention, a sign letter includes a front plate, a back plate, and a side wall disposed between the front and back plates with the side wall having material removed from an inner side thereof for subsequent bending or curving of the side wall for subsequent formation of the sign letter. Removal of material from the inner side of the side wall, allows for easy bending thereof during formation of the sign letter. According to one feature of the present invention, the side wall comprises one-piece construction and includes at least one feature, such as a groove or a shelf, for facilitating joining with the front and back plates of the sign letter. Such one-piece construction eliminates the need for additional parts to be either attached to the side wall or have the side wall further processed to form various bends for accommodating the front and back plates. In the preferred embodiment of the present invention, a computer generates a set of instructions for a router to cut at least one of the front plate, side wall, or back plates, identify locations of curvature and/or corners for the side wall, and remove material from the inside portion of the side wall to allow the wall to be bent during formation of the letter. Additionally, the computer includes instructions for locating a plurality of illuminating devices within the sign letter to optimize illuminating results. Thus, in a preferred embodiment of the present invention, a plurality of LEDs are automatically placed to optimize illuminating results.

According to another feature of the present invention, a filter system is included in the sign letter. The filter system includes either a filter body substantially conforming to the shape of the sign letter or filter patches strategically placed in register with the illuminating devices to compensate for variations in illuminating devices and to provide uniformity in illumination of the sign letters.

The foregoing and other advantages of the present invention become more apparent in light of the following detailed description of the exemplary embodiments thereof, as illustrated in the accompanying drawings.

### BRIEF DESCRIPTION OF THE DRAWINGS

FIG. 1 is a perspective schematic view of a system for fabricating sign letters;

FIG. 2 is a schematic perspective view of a sign letter of FIG. 1, according to the present invention;

FIG. 3 is a schematic perspective, exploded view of the sign letter of FIG. 2;

FIG. 4 is a schematic perspective view of a side wall of the sign letter of FIG. 2;

FIG. 4A is a schematic view of a side wall of the sign letter of FIG. 2 including an inner skin layer;

FIG. 5 is a schematic, fragmented, front view of a joint of wall segment ends of the sign letter of FIG. 2;

FIG. 6 is a cross-sectional view of the joint of wall segments of FIG. 5 taken along line 6-6;

FIG. 7 is a schematic, front view of a back plate with a plurality of illuminating devices of the sign letter of FIG. 2;

FIG. 8 is a schematic, cross-sectional view of the back plate and the illuminating devices of a sign letter taken along line 8-8 of FIG. 7;

FIG. 9 is a schematic, front view of a back plate with a plurality of illuminating devices of the sign letter of FIG. 2, according to another embodiment of the present invention;

FIG. 10 is a schematic cross-sectional view of the back plate with the plurality of illuminating devices of the sign letter taken along line 10-10 of FIG. 9;

FIG. 11 is a schematic cross-sectional view of the back plate with the plurality of illuminating devices shown in FIG. 10 according to another embodiment;

FIG. 12 is a schematic perspective view of a work surface with a front plate disposed thereon and a side wall being attached to the front plate using a block device;

FIG. 13 a schematic perspective view of a work surface with a front plate disposed thereon and a side wall being attached to the front plate using a magnet device;

FIG. 14 is an enlarged, perspective view of the block device for attaching the side wall to the front plate as shown in FIG. 12;

FIG. 15 is a schematic, fragmented, cross-sectional view of the sign letter of FIG. 2 taken along line 15-15;

FIG. 16 is an exploded, schematic view of a filter system for the sign letter of FIG. 2;

FIG. 17 is a front view of a letter of FIG. 2 with a filter system disposed thereon; and

FIG. 18 is an exploded, schematic view of another filter system for the sign letter of FIG. 2;

FIG. 19 is a schematic, cross-sectional view of a corner joining two wall segments of the sign letter of FIG. 2, according to another embodiment of the present invention;

FIG. 20 is a schematic, fragmented, cross-sectional view of the sign letter of FIG. 2 according to another embodiment of the present invention;

FIG. 21 is a side view of an extruded wall of the sign letter of FIG. 2 with a front plate and a back plate attached thereto;

FIG. 22 is a partially broken away front view of the extruded wall of FIG. 21;

FIG. 23 is a partially broken away top view of the extruded wall of FIG. 22;

FIG. 24 is a partially broken away side view of an extruded wall of the sign letter of FIG. 2 with a front plate and a back plate attached thereto;

FIG. 25 is a partially broken away front view of the extruded wall of FIG. 24;

FIG. 26 is a partially broken away top view of the extruded wall of FIG. 25;

FIG. 27 is a flow chart of a method for making the sign letter of FIG. 2.

### DETAILED DESCRIPTION OF THE PRESENT INVENTION

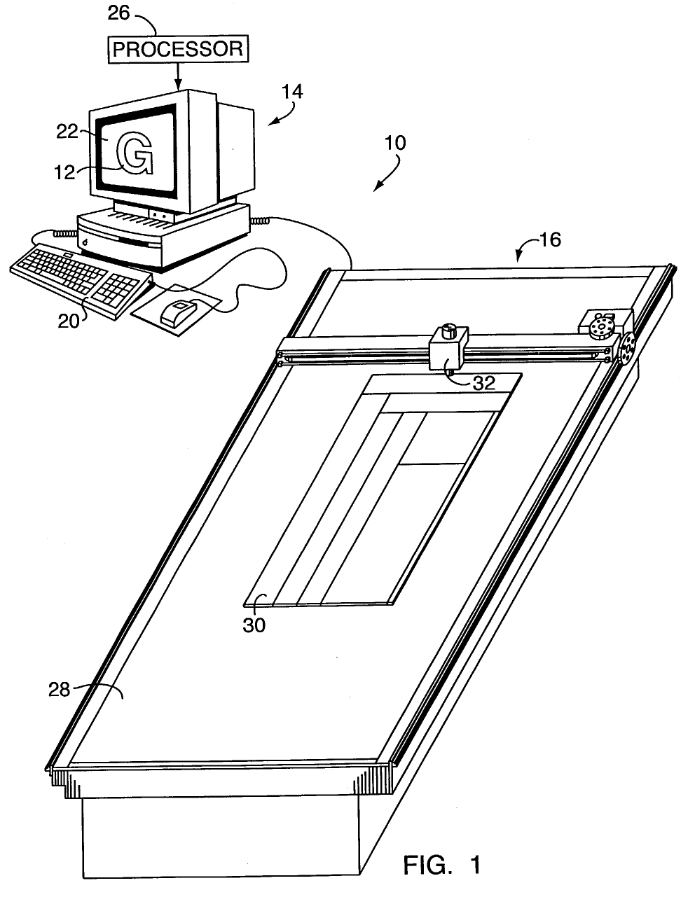

Referring to FIG. 1, a system 10 for fabricating a sign letter 12 includes a computer 14 controlling a router 16. The computer includes means for inputting data 20, such as a keyboard or a keypad, a screen 22 for viewing the sign letters 12, and a processor 26 for processing the data.

The router 16 includes a workbed 28 supporting sheet material 30 and a toolhead 32 for cutting the sheet material. Although any router can be used, one type of router is Sabre 408, manufactured by Gerber Scientific Corporation, assignee of the present invention. The router is described in U.S. Pat. No. 6,196,775 issued Mar. 6, 2001 and application numbers 09/425,505 filed Oct. 22, 1999 and 09/317,538 filed May 24, 1999, all incorporated herein by reference.

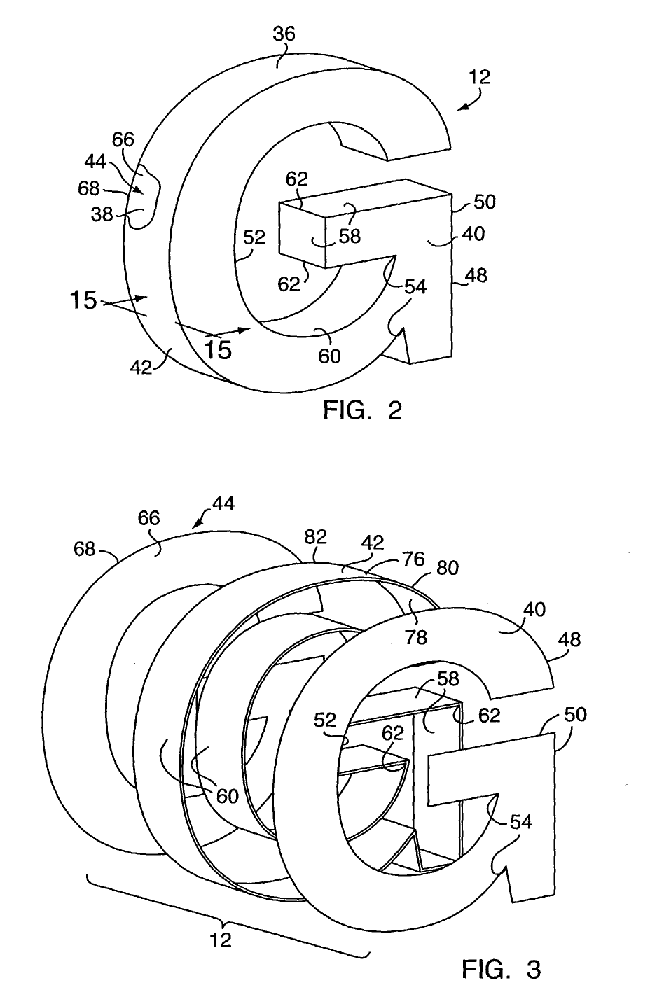

Referring to FIG. 2, each sign letter 12 includes a housing 36 defining an inner space 38. The housing is formed by a front plate 40, side wall 42, or return, and a back plate subassembly 44. The front plate has a thickness and a front plate edge 48 that substantially conforms to the contour of a particular sign letter and may include straight segments 50, curved segments 52, as well as corners 54.

The side wall 42 or return is fabricated from plastic, as will be discussed in greater detail below. The side walls may include straight segments 58, curved segments 60, and corners 62 that correspond to the straight segments 50, curved segments 52 and corners 54 formed in the front plate 40.

Referring to FIGS. 3 & 4, each wall section 42 has a predetermined thickness and includes an outer side 76 and an inner side 78 bound by a front plate edge 80 and a back plate edge 82. Each wall segment also includes substantially parallel first and second segment ends 84 that extend widthwise. In one embodiment of the present invention, a face groove 86 having a predetermined thickness is formed within the inner side 78 of the wall section 42 along the front plate edge 80 of the wall section to allow the front plate to subsequently fit therein. A shelf 88 having a predetermined depth is formed on the inner side 78 of the wall section along the back plate edge 82 thereof to subsequently receive the back plate subassembly 44. A plurality of cavities 89 is formed within the inner side 78 of the side wall to allow for subsequent bending or curving of the side wall section 42. Joint cavities 90 are formed on the inner side 78 of the wall section along the first and second segment ends 84 thereof for subsequent formation a joint 92, as best in FIGS. 5 and 6.

Although segment ends 84 of one wall section or multiple wall sections can also be glued together, in the preferred embodiment of the present invention, the joint 92 is formed by placing a joining piece 96, such as plastic, having a thickness, approximately equal to the depth of the joint cavity 90, is placed into the joint cavity of the wall section with glue or other securing means therebetween, as best seen in FIG. 5 and FIG. 6. This type of joint provides additional surface area for joining and securing two ends of the wall segment. Additionally, formation of the joint cavity ensures that a shadow from additional thickness does not show through the front plate of the sign letter.

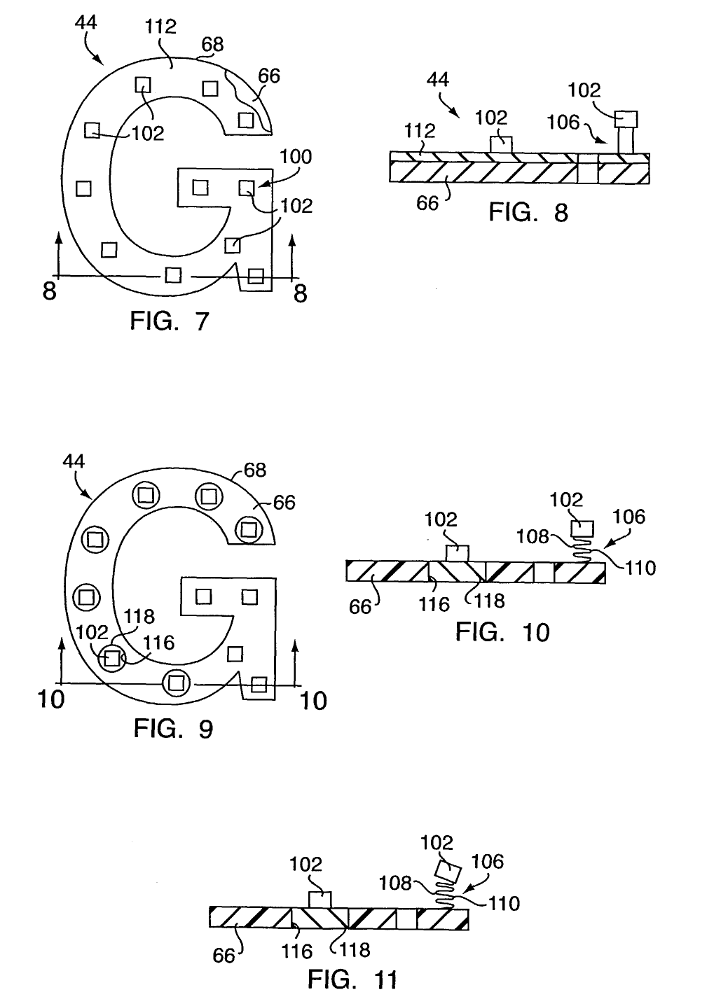

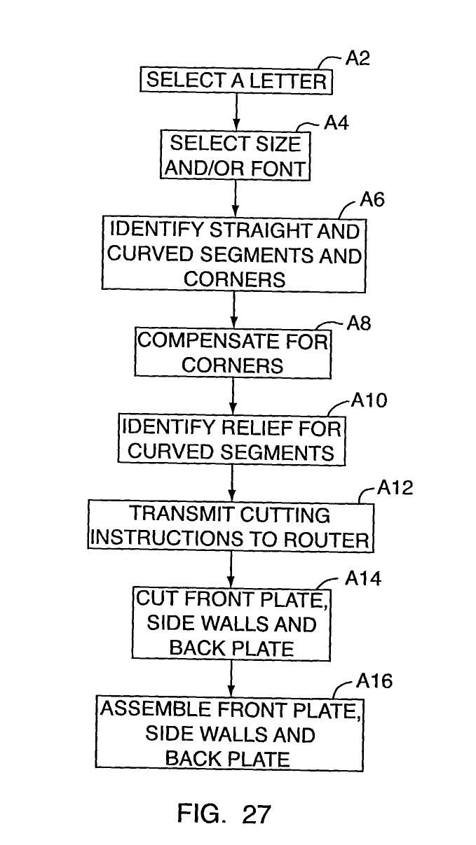

Referring to FIGS. 2 and 3, the back plate subassembly 44 includes a back plate 66 having a back plate edge 68 and substantially follows the contour of the front plate. Referring to FIGS. 7 and 8, the back plate subassembly 44 also includes a lighting system 100 which comprises a plurality of illuminating devices spaced about the back plate 66 to ensure uniform distribution of light throughout the letter. In the preferred embodiment, the illuminating device 102 is an LED. Additionally, some illuminating devices or LEDs may be placed on a stand-off 106. As a particular letter is selected to be fabricated into a sign letter and the information or data is inputted into the computer, the operator may select a particular font and size of the desired letter, as indicated by A2 and A4 in FIG. 27. The computer then displays the sign letter in the selected font and size on the computer screen for the operator's approval. Once the operator approves the shape of the letter, the computer processes the request and determines the length of each straight segment, the angle between the segments and/or radius for each curved segment. The computer subsequently commands the router to cut the front plate for the letter. The router cuts the front plate from the sheet or stock of plastic material in accordance with the instructions.

For signs comprised of multiple letters, the computer instructs the router to cut multiple front plates and multiple side walls. As the computer prepares the cutting instruction, the computer uses a nesting module to nest the front plates and side walls, thereby resulting in significant savings in material, as shown in FIG.1.

The computer also generates the cutting instructions for the side walls. The computer determines whether the length of the side walls requires the side walls to be fabricated from multiple segments or whether a single segment is sufficient to wrap around the entire letter. Regardless of whether the side walls are formed from a single segment or multiple segments, the ends of the wall segments form a joint when the segment ends are placed together.

The computer also determines the placement of corners, curved segments and straight segments, as indicated by A6 in FIG. 27. Once the corners and curved segments are identified, the computer provides cutting instructions that include cutting details regarding a degree of relief necessary for the curved and corner sections as indicated by A8 and A10.

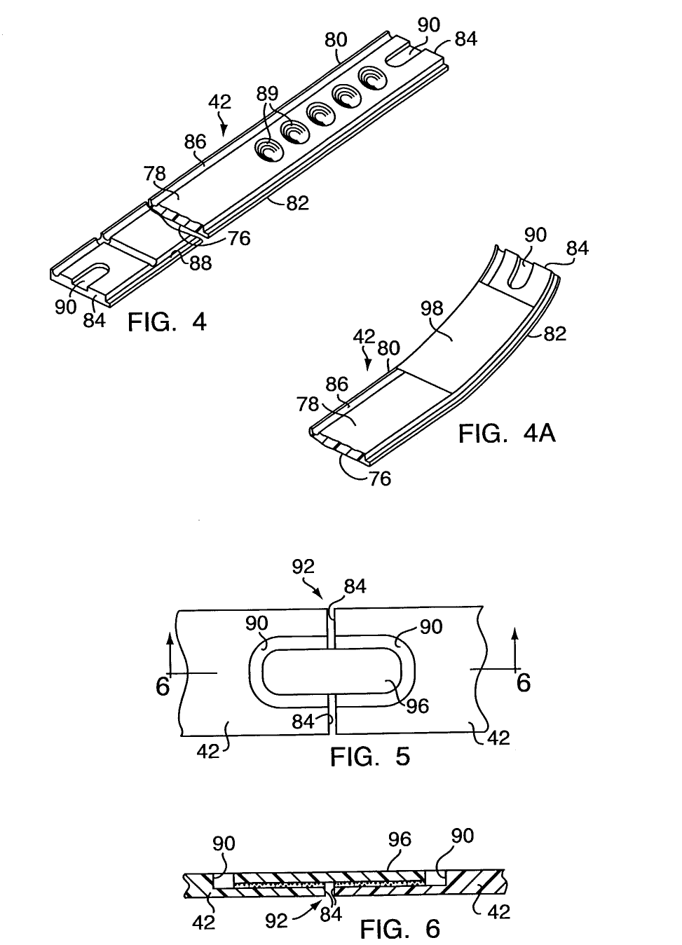

For curved segments, the router is instructed to remove various amount of material from the inner side of the wall segments, depending on the particular curvature, to relieve the particular curved area to allow the subsequent curving of the side wall, as shown in FIG. 4 and indicated by numeral 89. For the sharper curves, more material is removed for formation of a sharper curve. When a sign letter will form a slight curve and does not require significant curvature, the lesser amount of plastic material is removed to provide less of a relief. In the process of removing material from the side wall to make the wall more flexible, the structural integrity of the side wall may be compromised. This compromise may also occur at corners. To reinforce these areas of the walls, an inner skin 98 may be attached to an area of the wall that had material removed after the wall is positioned around the outside of the front plate, as best seen in FIG. 4A. The inner skin will also strengthen the area of the wall, which was relieved to make it more flexible.

The location of each LED 102 can be determined either manually or by a computer. In the preferred embodiment of the present invention, the computer dictates the locations of the LEDs. The LEDs, most likely, will not be equidistant from each other. For example, the corners of letters may require additional light to ensure that the front of the letter appears uniformly illuminated. However, in the preferred embodiment of the present invention, to preclude use of additional LEDs, certain LEDs, such as in corner locations, are placed on stand-offs 106, as indicated above and best seen in FIGS. 7-11. In certain configurations, the LEDs may be too intense to generate an even illumination of the front plate. In such event, the computer may suggest placing defuses or filters over certain LEDs to spread the light more evenly to the front plate, as will be discussed in greater detail below.

The computer identifies location of each LED, including those that are disposed on stand-offs. According to the present invention, stand-offs can be used for placing LEDs in closer proximity to the front plate. Additionally, stand-offs can be used with less expensive or dimmer LEDs to reduce the cost of the overall assembly. For example, a cheaper LED can be placed on a stand-off to reduce the cost of the overall assembly rather than to use a more expensive and brighter LED without the stand-off. The final assembly may, therefore, include a combination of more expensive, brighter LEDs and less expensive, dimmer LEDs placed on stand-offs, if necessary.

Although various types of stand-offs can be used, in the preferred embodiment of the present invention, an adjustable stand-off 108 is used, as best seen in FIGS. 10 and 11. The adjustable stand-off 108 comprises a spring-like body 110 that can be moved upward or downward. The height of the stand-off 108 can vary and is determined by the computer for optimum results. Additionally, the adjustable stand-off 108 can be moved to direct the light of the LED 102 at an angle, if necessary.

The back plate, in the preferred embodiment of the present invention, is formed on the router from metal. In the preferred embodiment, the back plate subassembly also includes a reflective layer 112, as best seen in FIG. 7 and FIG. 8. In the preferred embodiment, the reflective layer 112 is a light enhancement film for enhancing the effect of light. Although various reflective layers can be used, one type is Scotchal™ Marking Film (number 3635-100) sold by 3M Company of Minnesota. The reflective film can also be placed on the inner side of the wall sections to further enhance the light effect.

In an alternate embodiment of the present invention, the back plate is fabricated from plastic, as best seen in FIG. 9 and FIG. 10. The back plate 66 includes a plurality of openings 116 corresponding to the location of the LEDs. Each LED 102 is mounted onto a metal disk 118 which is, in turn, mounted into the back plate opening. The disk has a dual purpose of serving as a heat sink for the LEDs and allowing servicing of the LEDs. Thus, the disk can be removed if the LED needs to be serviced. The disk can also serve as a reflector to aid in directing and focusing the LED light.

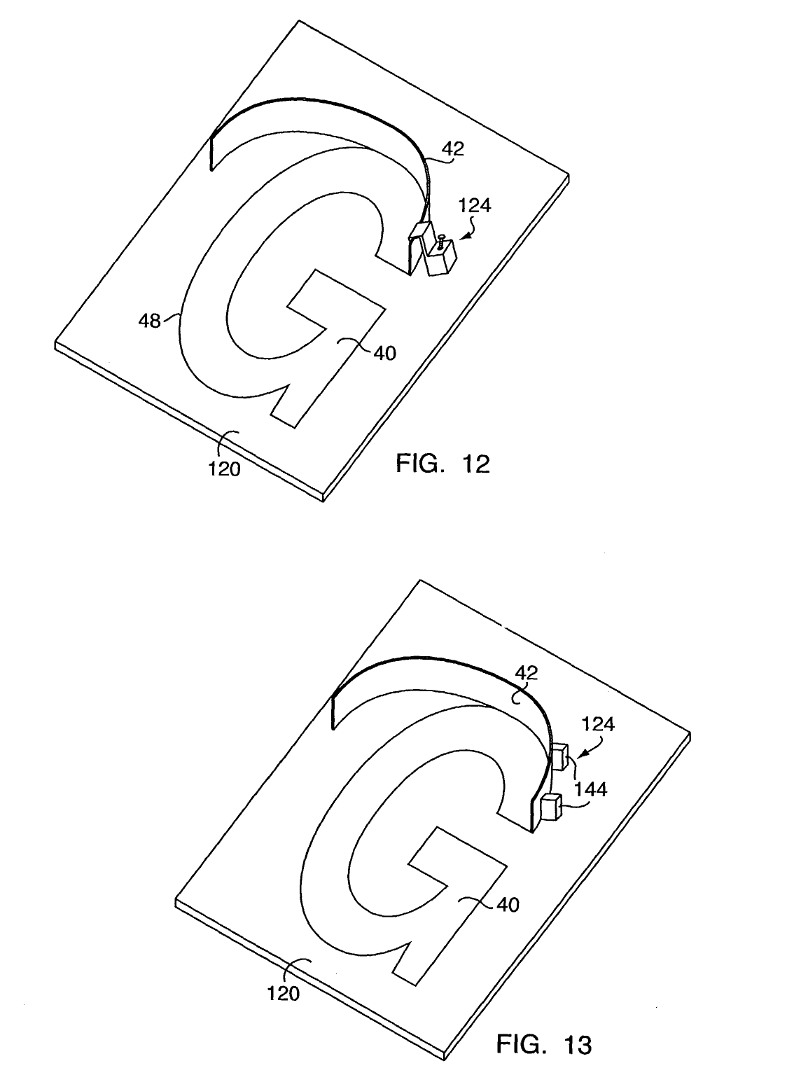

Once the front plate and the wall sections are formed, they are assembled together, as best seen in FIG. 12 and indicated by A14 and A16 in FIG. 27. The front plate 40 is placed onto a substantially flat working surface 120. The wall section 42 is then wrapped around the front plate edges such that the front plate edges 48 fit into the front plate groove 86 formed within the wall section. The front plate and the wall section are joined together either automatically with use of a machine or manually. The joint can be formed using plastic welding, tape, glue or other joining means. To aid a manual process, a plurality of retaining devices 124 is used.

In a further alternate embodiment, the walls can be assembled to the back plate instead of the front plate. The front plate can be assembled to the side wall in a similar manner as is common for mounting the front plate to metal cans.

Referring to FIG. 14, in one embodiment, the retaining device 124 is a block device. Each block device includes a block body 126 and a pin 128. The block body includes a substantially flat base surface 130 and a substantially straight support surface 132 that is substantially perpendicular to the base surface. The block body also includes a through hole 134 passing through the base surface for receiving the pin. The through hole is formed at an approximately five degree (5°) angle with respect to the support surface. In the preferred embodiment of the present invention, the block device also includes a cap portion 136 with a detent 138 protruding outward, substantially perpendicularly to the support surface. The pin, in the preferred embodiment of the present invention, is a nail with a sharpened end 140 protruding through the base surface and a substantially flat end 142 extending outwardly for absorbing the driving force.

In operation, the block device is used to aid assembly of the wall section with the front plate. As the first segment end is joined with the front plate, as can be dictated by the computer, a block device is placed onto the work surface with the base surface resting against the work surface and with the support surface being placed substantially adjacent to the wall section such that the support surface of the block device is in close proximity to the outer side of the wall section with the cap portion of the block device overhanging of the back plate edge of the wall section. The nail is subsequently driven into the work surface, thereby forcing the block device closer to the wall section, until the support surface of the block device is substantially adjacent to the outer side of the wall section. Thus, the block device maintains the wall section in place with respect to the front plate. The cap portion precludes the wall section from lifting from the work surface.

Referring to FIG. 13, in accordance with another embodiment, the retaining device 124 is a magnet device 144 that is attracted to a metal work surface to retain the wall section and the front plate together. One benefit of the magnet device is its simplicity and cost effectiveness.

Several retaining devices can be used to maintain portions of the wall section in place while the entire wall section is positioned around the front plate. As the front plate edges 48 are fitted into the front plate groove 86 of the wall section, the interface is secured together with either glue or other securing means. One type of glue that can be used is cyanoacrolate glue fabrication by Henkel Loctite Corp. of Rocky Hill, Conn.

In the most preferred embodiment, the plastic wall sections are heated at various bend points such as corners or curved segments. The wall section can be heated either with hot air or by other methods. The temperature is measured and monitored as the wall section is bent to conform to the contour of the front plate.

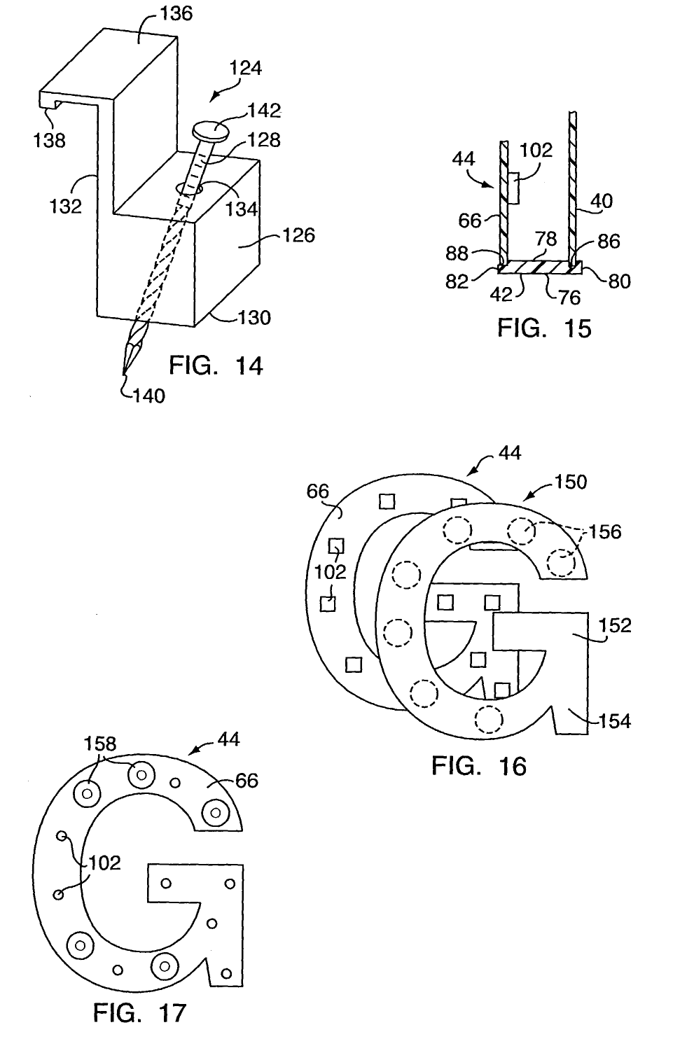

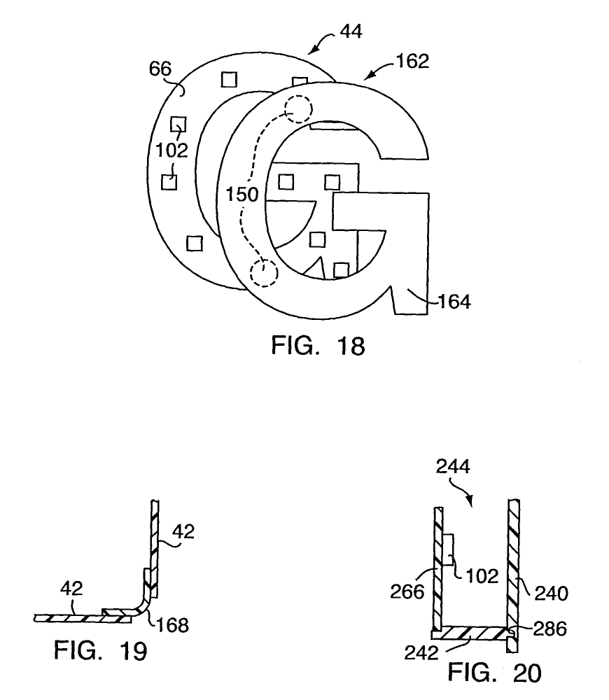

Once the wall section is joined and secured with the front plate, the back plate subassembly is placed onto the wall section, fitting onto the shelf and secured thereonto with either glue or other securing means, as best seen in FIG. 15.

According to one feature of the present invention, a filter system 150 provides color uniformity in sign letters, as best seen in FIG. 16. According to one embodiment of the present invention, the filter system comprises a filter 152 having a filter body 154 with a contour substantially conforming to the contour of the front plate and being fabricated from translucent or transparent material. The filter 152 includes a plurality of dots 156 disposed over locations of various LEDs. Each dot has a complementary filtering color to compensate for variations among the LEDs. For example, if the LED has a bluish tint, a yellow and magenta dot is printed on the filter. For a yellowish LED, a magenta and cyan dot is printed. For the red colored LED, yellow and cyan colored dots are printed. The filter can be printed on the Gerber EDGE® printer, manufactured by Gerber Scientific Products, assignee of the present invention. The computer has the information regarding locations of the LEDs. The color deviation of each LED can be generated through a sensing means such as a meter to sense color deviation of each LED. The filter 152 then can be overlaid onto the front plate to provide a uniform overall effect of the letter.

In another embodiment of the present invention, the filter system 150 includes at least one individual or a plurality of filter patches 158 provided for each LED separately, as shown in FIG. 17. Once it is detected that one or more LEDs have non-uniform color, the individual filter 158 can be locally applied to that LED. Such an individual filter patch 158 can be either a cellophane dome, paint, vinyl or vinyl patch manufactured as process color on a transparent media such as is possible with a Gerber EDGE® or ink jetting process. Gerber EDGE® is a product of Gerber Scientific Products, Inc. of South Windsor, Connecticut, and assignee of the present invention. These filtering elements will aid in diffusing the light-preventing shadowing.

In a further embodiment of the present invention, the LED filtering can occur prior to placement of LEDs onto the back plate. Thus, each LED can be tested and a filter applied to the LED prior to the application of LEDs into the product.

In a further embodiment of the present invention, LEDs of different colors and light output can be placed inside the sign letter to change the overall light quality (color, intensity) being emitted by the letter. The selection and location of various LEDs can be determined by the computer system to adjust for the light output of the general population of the LEDs in the letter. This technique may also be used to generate certain lighting effects. The filter system 150 can be automatically generated by the computer to compensate for variations in LEDs and to ensure uniformity.

As a further embodiment of the present invention, a color panel 162 can be printed on a printer or a signmaker, such as Gerber EDGE®. The color panel includes a color panel body 164 having a color panel body shape substantially similar to the shape of the front plate of the sign letter. The color panel is fabricated from transparent or translucent material, one such material can be a vinyl. The color panel is then placed onto the front plate to provide color therefor. The color panel may also include a filter system 150. Thus, the printer or signmaker can be commanded to print a filtering scheme onto the color panel in conjunction with a particular color. In this embodiment of the present invention, the front panel can be fabricated from clear stock for all sign letters and have the color panel added for each letter. This would eliminate the need to maintain large stock of colored plastic for fabrication of front plate and also increase color choices for the front plate.

According to a further feature of the present invention, hot stamped foil in various colors and patterns can be fused onto the white or plain side walls of the letters. In traditional signmaking, the metal parts are typically spray painted with a desired color. However, spraying metal parts is an extremely messy and time consuming process that requires a special room for spray painting and additional time for drying the paint. Using hot stamped foil fused onto the walls of the letters provides numerous advantages. First, fusing hot stamped foil onto the walls with a heat roller or to the wall during the extrusion process, is significantly less time consuming and messy than the traditional spray painting method. Additionally, hot stamped foil provides a choice of additional or custom colors, including metallics that are not available with spray painting. Furthermore, fusing the hot stamped foil onto the walls reduces material inventory.

In another embodiment of the present invention, the wall segments are cut by the router such that no corners need to be formed. Each wall segment is cut to the length of the segment, resulting in multiple wall segments. Subsequently, the wall segments are joined at each corner by a corner joint 168, as can best be seen in FIG. 19. For this purpose, different thickness' of material can be used. For example, for straight segments thicker plastic can be used, whereas for curved segments thinner material can be used to facilitate bending of the curved segment. Therefore, for straighter segments when thick material can be used, less material needs to be removed from the original stock by the router.

In a further alternate embodiment of the present invention, the front plate 240 is cut to extend a predetermined distance outwardly from the edges or overhang the wall sections 242, as best seen in FIG. 20. A groove 286 is then formed within the front plate, substantially around the edges thereof. The groove has a predetermined thickness sufficient to receive the wall section therein. Thus, the wall section fits into the groove of the front plate with the overhang extending past the wall section. This provides a different look to the sign letter.

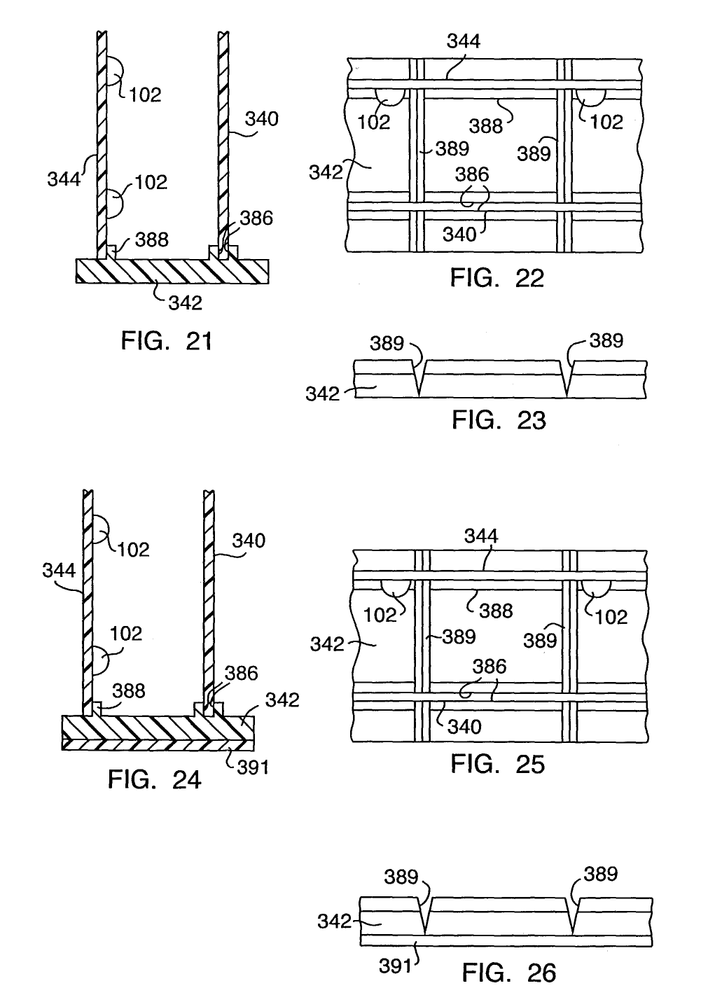

In a further alternate embodiment of the present invention, the initial plastic stock can be extruded, as best seen in FIGS. 21-23. The extruded stock 342 includes features for supporting the front and back plates 340, 344. For example, the extruded stock may include a shelf 388 for the back plate 344 and a groove 386 for the front plate 340. The groove 386 serves to locate and lock the front panel and can be used in conjunction with an adhesive to retain and seal the front panel. Subsequently, a router can be used to form various relieves 384 for forming curves and grooves 389 for forming corners. Thus, the router is subsequently used to remove material from the extruded stock to form curves and corners. The corners and curves can be formed manually since the removed material allows for easy bending. However, this embodiment results in additional savings in time by eliminating a significant amount of work performed on the router.

In an additional alternate embodiment of the present invention, the extruded stock can be co-extruded with additional material, as best seen in FIGS. 24-26. For example, a layer of polyethylene or PVC 391 can be co-extruded with the plastic stock 342 to render the plastic stock more flexible, and thus, less likely to break at the corners or where relieves have been formed. Once the co-extrusion has been formed, the router is used to form additional features 389 for corners and/or relieves 389 for curves.

In a further embodiment of the present invention, a metal stock can be used as sheet material. The router can be also used to remove metal material for formation of bends. Such use of metal stock would also allow hand bending of side walls into the sign letters.

One advantage of the present invention is that sign letters can be fabricated mostly automatically. More specifically, the computer, in cooperation with the router, generates and cuts, respectively, portions of the letter. This eliminates the need for forming each letter manually. Additionally, the computer and the router nest the necessary parts prior to cutting to optimize use of material. Another benefit of using a router is to relieve the plastic or even metal for forming curved segments and/or corners.

Another benefit of using a computer is that the location of the LEDs can be optimized for brightness and/or color balance as well as for lack of shadows, resulting in savings in time and cost. Additionally, the computer may include a database of all LED manufacturers to optimize the final product based on the LED manufacturer used for a particular letter. For example, various manufacturers fabricate LEDs with particular characteristics. Using the database of the LED manufacturers, each letter can be optimized for either cost, quality and/or other features.

Another advantage of the present invention is that the letters are fabricated from plastic. One benefit of plastic letter is that gluing plastic parts saves time over traditional riveting and/or welding metal parts. Additionally, fabricating letters from plastic, in accordance with the present invention, requires a lower skill level of people fabricating the letters.

Another advantage of the present invention is that the LEDs can be used instead of neon to provide lighting to the sign letters. The LEDs are much more efficient than neon since LEDs require lower voltage and lower temperature. Additionally, LEDs are less hazardous than neon.

A further advantage of the present invention is that some of the LEDs are placed on stand-offs to enhance the uniformity of lighting the signs, thereby decreasing the required number of LEDs, resulting in cost savings in additional parts, such as LEDs, and additional electrical costs for usage thereof.

A further advantage of the present invention is that the joint between ends of wall segments does not result in obstruction in the final product.

Another advantage of the present invention is that one-piece construction of the side wall eliminates additional parts that are typically used in traditional letter making. A trim cap, typically used with metal letters, is no longer needed, resulting in additional cost savings. Furthermore, the shelf or groove are integrally formed within the side wall.

Although the present invention has been described with the most preferred embodiments, other deviations and changes therefrom are within the scope of the present invention. For example, although the present invention is described with respect to a router, other equipment to cut and remove material such as engraving, etching, or milling equipment can be used. Additionally, although the present invention is described primarily with respect to LEDs, other illuminating devices, including neon, or various combinations thereof can be used. Furthermore, the present invention includes formation of a side wall from extruded plastic, however, a side wall can also be formed from metal stock that has been previously bent to include certain features, such as a shelf for the back plate and a shelf for the front plate. Such metal stock can have material removed therefrom to form cavities and relief features to allow easy bending of the side walls to form a sign letter.

We claim:

1. A sign letter comprising:
a front plate having a front plate shape;
at least one side wall comprising one-piece construction, said at least one side wall and said front plate being adapted to be joined together;
a back plate having a substantially similar shape to said front plate shape, said back plate and said at least one side wall being adapted to be joined together to define a sign letter housing; and
a lighting system for illuminating said sign letter, said lighting system fitting into said sign letter housing.

2. The sign letter according to claim 1 wherein said at least one side wall includes a groove integral thereto to facilitate joining of said at least one side wall with said front plate.

3. The sign letter according to claim 1 wherein said at least one side wall includes a shelf formed integral thereto to facilitate joining of said at least one side wall with said back plate.

4. The sign letter according to claim 1 wherein said at least one side wall includes cavities resulting from material being removed therefrom at predetermined locations for subsequent formation of curved segments and corners.

5. The sign letter according to claim 4 wherein said sign letter further includes an inner skin layer placed substantially adjacent to said at least one side wall.

6. The sign letter according to claim 1 wherein said at least one side wall is fabricated from plastic.

7. The sign letter according to claim 6 wherein additional material is removed from said plastic stock to facilitate subsequent bending of said at least one side wall.

8. The sign letter according to claim 1 wherein said at least one side wall is fabricated from metal.

9. The sign letter according to claim 1 wherein said at least one side wall is fabricated from extruded plastic stock already including certain features for facilitating joining of said side wall and one of said front plate or said back plate.

10. The sign letter according to claim 9 wherein said extruded stock is co-extruded with a layer of polyethylene.

11. The sign letter according to claim 1 wherein said front plate, said at least one side wall and said back plate are automatically cut by a router in accordance with a set of instructions generated by a computer.

12. The sign letter according to claim 1 wherein said sign letter comprises a plurality of side walls around a contour of said sign letter.

13. The sign letter according to claim 12 wherein said plurality of side walls are joined together to form a continuous side wall.

14. The sign letter according to claim 12 wherein said plurality of side walls are joined by the means of glue.

15. The sign letter according to claim 1 wherein said at least one wall end includes segment ends on each end thereof extending widthwise, each said segment end includes a joint cavity formed therein to accept a joining piece to facilitate joining of two ends of said side walls.

16. The sign letter according to claim 1 wherein at least one of said front plate, said at least one side wall, or said back plate are generated on a router in accordance with instructions generated by a computer for said router, said instructions including identification of straight and curved segments, compensation for corners, thereby directing said router to remove material from said side wall to allow bending of said at least one side wall to a predetermined curvature or angle.

17. The sign letter according to claim 1 wherein said lighting system includes a plurality of illuminating devices.

18. The sign letter according to claim 17 wherein said illuminating devices are LEDs.

19. The sign letter according to claim 17 wherein said illuminating devices are neon.

20. The sign letter according to claim 17 wherein placement of said plurality of illuminating devices is dictated by a computer for optimum results.

21. The sign letter according to claim 17 wherein said sign letter further comprises a reflecting layer placed between said back plate and said plurality of illuminating devices.

22. The sign letter according to claim 17 wherein each of said plurality of illuminating devices is mounted on a disc with said disc being inserted into an opening formed within said back plate.

23. The sign letter according to claim 17 wherein some of said plurality of illuminating devices are placed on a stand-off to optimize illuminating effect.

24. The sign letter according to claim 23 wherein said stand-off is adjustable.

25. The sign letter according to claim 24 wherein said stand-off comprises spring-like body to be adjusted for height and angle.

26. The sign letter according to claim 23 wherein said stand-off allows height adjustment of said illuminating device.

27. The sign letter according to claim 23 wherein said stand-off allows angle adjustment of said illuminating device.

28. The sign letter according to claim 1 further comprising:
a filtering system for compensating for variation in LEDs included in said lighting system.

29. The sign letter according to claim 1 wherein said front plate includes a groove for joining with said at least one side wall.

30. The sign letter according to claim 29 wherein said groove is formed inward of a front plate edge substantially following said front plate shape.

31. A sign letter comprising:
a front plate having a front plate contour;
a back plate having a back plate contour substantially similar to said front plate contour;
a side wall having at least one feature for allowing joining of said side wall with at least one of said front plate or said back plate, said side wall having at least one cavity wherein side wall material has been removed to form said cavity, said at least one cavity being located for subsequent bending of said side wall to confirm to contour of said front plate and said back plate.

32. A method for fabricating a sign letter comprising the steps of:
selecting a particular sign letter for fabrication;
generating instructions on a computer for fabricating said sign letter;
fabricating a front plate by cutting around a contour of said front plate having a front plate contour in accordance with said instructions;
fabricating at least one side wall from material stock;
forming at least one feature within said side wall for subsequent joining of said side wall with at least one of said back plate or said side plate;
fabricating a back plate having a back plate contour substantially similar to said front plate contour;
removing side wall material from said side wall to form a cavity facilitating subsequent bending of said side wall; and
providing a lighting system for illuminating said sign letter.

33. The method according to claim 32 wherein said at least one feature is a groove.

34. The method according to claim 33 wherein said groove is integrally formed within said at least one side wall.

35. The method according to claim 32 wherein said at least one feature is a shelf.

36. The method according to claim 35 wherein said shelf is integrally formed within said at least one side wall.

37. The method according to claim 32 wherein said instructions include instructions for identifying a shape of said sign letter, identifying location of bends within said at least one side wall and identifying amount of material necessary to be removed from said at least one side wall to allow said at least one side wall to be subsequently bent in order to form said sign letter.

38. A method for fabricating a sign letter comprising the steps of:
selecting a particular sign letter for fabrication;
identifying location of bends and corners on a side wall of said sign letter;
removing material from an inner side of said side wall to form at least one feature for allowing subsequent bending of said side wall.

39. A method according to claim 38 wherein said step of identifying location of bends and corners is performed automatically on a computer and wherein said step of removing material is performed on a router receiving cutting instructions from said computer regarding location of said bends and corners.

40. A lighting system for use in a sign letter comprising:
a plurality of illuminating devices disposed within a sign letter housing of a sign letter wherein placement of said plurality of illuminating devices is computer generated to optimize uniform illumination of said sign letter.

41. The lighting system according to claim 40 wherein placement of said plurality of illuminating devices is optimized for cost benefits.

42. The lighting system according to claim 40 wherein placement of said plurality of illuminating devices is optimized to compensate for variation in illuminating devices.

43. The lighting system according to claim 40 wherein placement of said plurality of illuminating devices is based on particular characteristic of each illuminating device of said plurality of illuminating devices.

44. The lighting system according to claim 40 further comprising:
a filter system for filtering light emitted by at least one illuminating device from said plurality of illuminating device to provide uniform light emission.

45. The lighting system according to claim 40 wherein said illuminating device is an LED.

46. The lighting system according to claim 40 wherein at least one of said plurality of illuminating device is placed on a stand-off.

47. The lighting system according to claim 46 wherein said stand-off is an adjustable stand-off.

48. The lighting system according to claim 47 wherein said adjustable stand-off comprises a spring-like body with an illuminating device mounted thereon to adjust position of said illuminating device within said sign letter housing.

49. A filter system for use with a sign letter, said filter system comprising:
at least one filter for use in conjunction with a sign letter to compensate for variations in illuminating devices.

50. The filter system according to claim 49 wherein said filter includes a filter body having a filter body shape substantially similar to a shape of a front plate of said sign letter wherein at least one area of said filter body is colored to provide appearance of uniformity in illumination of said sign letters.

51. The filter system according to claim 49 wherein said filter is at least one filter patch to be strategically placed in register with at least one illuminating device.

52. The filter system according to claim 49 wherein said filter comprises a plurality of filter patches with each patch being placed on said front plate of said sign letter.

53. The filter system according to claim 49 wherein said filter comprises a color panel having a color panel shape substantially similar to a shape of a front plate of said sign letter wherein at least one color is applied onto said color panel to provide color for said front plate of said sign letter.

54. The filter system according to claim 53 wherein said color panel includes additional colors to compensate for variations in LEDs.

55. The filter system according to claim 53 wherein said color panel is fabricated from vinyl material.

56. A system for generating sign letters comprising:
means for cutting at least one of a front plate, side wall or back plate for a sign letter; and
processor means including instructions for said means for cutting to cut at least one of said front plate, side wall or back plate, said processor means also including instructions for placing illuminating devices within said sign letter for optimal illumination results.

57. The system according to claim 56 wherein said means for cutting is a router.

58. The system according to claim 57 wherein said router removes material from said side wall in accordance with said instructions to allow subsequent bending of said side wall.

59. The system according to claim 56 wherein said-means for cutting is an engraver.

60. The system according to claim 56 wherein said illuminating device is an LED.

61. The system according to claim 56 wherein said illuminating device is neon.

62. The system according to claim 56 wherein said processor means further includes instructions for placement of a filter system relative to said illuminating devices.

63. The system according to claim 62 wherein said filter system is placed to compensate for variations in illuminating devices.

64. A system for generating sign letters comprising:
means for cutting stock for a sign letter; and
processor means including instructions for said means for cutting to remove material from said stock to allow bending of a side wall for subsequent forming of said sign letter.

65. A system according to claim 64 wherein said means for cutting is a router.

66. A system according to claim 1 further comprising:
a color panel having a color panel shape substantially identical to said front plate shape, said color panel being disposed substantially adjacent to said front plate.

67. A system according to claim 66 wherein said color panel is fabricated from vinyl.

68. A system according to claim 66 wherein said color panel provides color to said front panel.
